(19) United States
(12) Patent Application Publication
(10) Pub. No.: US 2012/0207178 A1
(43) Pub. Date: Aug. 16, 2012

(54) SYSTEMS AND METHODS UTILIZING LARGE PACKET SIZES TO REDUCE UNPREDICTABLE NETWORK DELAY VARIATIONS FOR TIMING PACKETS

(76) Inventor: Charles A. Webb, III, Austin, TX (US)

(21) Appl. No.: 13/352,106

(22) Filed: Jan. 17, 2012

Related U.S. Application Data
(60) Provisional application No. 61/441,719, filed on Feb. 11, 2011.

(51) Int. Cl. H04L 12/54

(52) U.S. Cl. 370/429

(57) ABSTRACT

Systems and methods are disclosed for utilizing large packet sizes to reduce unpredictable network delay variations in delivering timing packets across networks for use with respect to network timing protocols. By increasing the size of the timing packets, the disclosed embodiments reduce or eliminate the blocking effect caused by size differences between timing packets and relatively large packets carried through a packet network. By reducing or eliminating this blocking effect, the disclosed embodiments provide significant advantages in reducing the complexity of implementing robust timing protocols for handling unpredictable delays in the communication of timing packets. The size of timing packets can be increased, for example, by adding fill data to timing data to form large timing packets. A variety of large packet sizes can be used for the timing packets, and timing packets can preferably be made to be equal to the maximum transmission unit (MTU) for the network.

### RELATED APPLICATIONS

This application claims priority to the following co-pending provisional application: U.S. Provisional Patent Application Ser. No. 61/441,719, filed Feb. 11, 2011, and entitled “SYSTEMS AND METHODS UTILIZING LARGE PACKET SIZES TO REDUCE UNPREDICTABLE NETWORK DELAY VARIATIONS FOR TIMING PACKETS,” which is hereby incorporated by reference in its entirety.

### TECHNICAL FIELD OF THE INVENTION

This invention relates to the use of timing packets to provide timing synchronization in network communications and, more particularly, to address network delay variations in the transmission and receipt of such network timing packets over network links.

### BACKGROUND

There is often a need with electronic systems to synchronize timing between devices operating on wired and/or wireless networks. Protocols have been developed that use timing packets transmitted and received between such devices to facilitate timing synchronization. These protocols include PTP (Precision Time Protocol) and NTP (Network Time Protocol). PTP and NTP both utilize timing packets communicated between devices to provide for timing synchronization of local clocks.

Timing protocols, such as PTP and NTP, are often utilized with packet-based communication protocols, such as the Ethernet or IP (internet protocol) network protocols, that allow variable packet sizes. Variable packet sizes are utilized to increase the efficiency of the packet transmission through network links. Because the packet header information is processed by each network link, an increase in the number of packet headers that must be processed for a given communication stream may also increase the time required to complete the data transfer. Similarly, for packets where the number of headers is constant but the size of the payload varies, the relative proportion of time spent transmitting headers is greater for smaller packets. As such, the data payload for packets can be increased for large data transfers so that fewer packets can be utilized for the data transfer, with each packet including larger data payload. While individually large packets are processed more slowly than small packets, the large packets reduce the overall communication time for large data transfers as compared to the use of many small packets due to the reduced number of headers that are processed. Thus, network communication protocols, such as Ethernet and IP based networks, allow for variable packet sizes, and large packet sizes are utilized for large data transfers.

The timing data used for timing packets for timing protocols, such as the PTP and NTP timing protocols, however, is relatively small. As such, small packets are used to send this timing information so that network capacity is used efficiently. Further, these small timing packets are typically marked as the highest priority packet type. As such, each network link will process the timing packets first as compared to other lower priority packets that have been received at the same time.

One feature of certain networks, such as Ethernet or IP based networks, is that packets received by a network element or node are fully received before they are processed further. This store-and-forward operation means that packets must be fully received before they can be further processed for forwarding on to another network node or link.

Another feature certain networks, such as the Ethernet or IP based networks, is that once transmit processing of a packet has started on an egress port within a network link or node, that processing must be completed before transmit processing of another packet can begin on that same egress port. Thus, if a network link or node has already started processing a large data packet when a small timing packet is received by that network link or node, the small timing packet must wait behind the large data packet until it has been completed. A data packet that blocks another smaller data packet is often called a blocker packet.

Blocker packets, particularly large blocker packets, can create unpredictable delay variations for smaller packets as they travel through networks. With respect to small timing packets, therefore, blocker packets create wide variations in network delays as these small timing packets progress through network links or nodes. And these delays are unpredictable as some timing packets will encounter blocker packets and other timing packets will not encounter blocker packets. Because a number of different timing packets are typically sent between devices to synchronize timing and the network delay is often part of the timing calculation, these unpredictable variations in network delay associated with timing packets creates problems for devices trying to accurately determine relative timing information for synchronization purposes.

FIG. 1A (Prior Art) is a block diagram for a network system 100 including a packet timing master device 102 and a packet timing slave device 106 communicating through a network across one or more intervening network elements or nodes 104. Packet master and slave devices are utilized, for example, in the NTP and PTP standards mentioned above. In the embodiment depicted, the packet timing master device 102 includes a packet interface 110, a timing packet generator 112 and timing data 114. The timing packet generator 112 uses the timing data 114 to form a timing packet that is provided to the packet interface 110 for transmission across the network. As described above, timing packets are small in size. Because of this small size, the timing packets will travel more quickly through the network, and timing packets are typically tagged with a high priority designation so that network elements or nodes 104 will process them first over lower priority packets. The small timing packets 116, therefore, are processed by one or more network elements or nodes 104 and then provided as small timing packets 116 to the destination or receiving device, which is the packet timing slave device 106 in network system 100. In the embodiment depicted, the packet timing slave device 106 includes a packet interface 120, a timing packet parser 122 and timing data 114. The packet interface 120 receives the small timing packets 116 and provides them to timing packet parser 122. Timing packet parser 122 obtains the timing data 114 from the timing packet 116, and this timing data 114 can then be used for timing synchronization.

It is noted that timing protocols, such as PTP and NTP, often require that the synchronizing devices send timing packets back and forth between each other for timing synchronization. As such, in addition to timing data 114 sent from the packet timing master device 102 to the packet timing slave device 106, timing data would be sent back to the packet timing master device 102 from the packet timing slave device 106. Further, additional timing data could be used by the packet timing master device 102 and/or the packet timing slave device 106 other than the data received from each other. For example, in certain network timing protocol solutions, a master device will send timing data to a slave device in a timing packet including a SEND timestamp for this master timing packet. The slave device will receive this master timing packet and compare the master SEND timestamp to its own locally generated RECEIVE timestamp. The slave device will then send a timing packet back to the master device. The slave will store the SEND timestamp for this return slave timing packet. The master device will then receive this slave timing packet and its own locally generated RECEIVE timestamp. The master device will then send a timing packet back to the slave device now including the RECEIVE timestamp associated with the slave timing packet. The slave device now has four timestamps, i.e., SEND and RECEIVE timestamps for the timing packet sent from the master device to the slave device, and SEND and RECEIVE timestamps for the timing packet sent from the slave device to the master device. These four timestamps can be used to calculate the round-trip time from the master device to the slave device. If the network between the master device and the slave device is symmetric, the four timestamps can also be used to form an estimate of the one way delay between the master and slave, and the slave can then use this information to synchronize its clock with the master's clock. This back and forth communication continues so that the two devices can synchronization their local clocks with each other.

As described above, during their journey through intervening network elements or nodes 104, the small timing packets 116 may or may not encounter one or more large blocker packets 130. These large blocker packets 130 can add significant delay to the transit time of a timing packet, should a timing packet be blocked by one or more blocker packets 130. Thus, a wide packet delay variation 132 can be experienced by the small timing packets 116. In other words, some of the small timing packets 116 may be relatively fast as they travel through the intervening network elements or nodes 104, and some of the timing packets 116 may be relatively slow as the travel through the intervening network elements or nodes 104, depending upon what large blocker packets 130 they encounter. Thus, wide variation in packet delay is experienced, and these delays are unpredictable. It is noted that the large blocker packets 130 may leave the intervening network nodes 104 and travel to the same packet timing slave device 106 or to other network connected devices. It is further noted that in addition to large blocker packets 130, other packets of differing sizes will likely enter and leave the intervening network nodes 104, and these additional packets may also interfere with and delay the small timing packets 116.

FIG. 1B (Prior Art) is a graphical depiction 150 of a large blocker packet 130 and a small timing packet 116 progressing through network nodes. For the first node timeline 160, the blocker is received and processed before the small timing packet 134 is received and processed. Gap 153 represents the time lapse from the end of large blocker packet 130 being processed by the first node and that start of processing for the small timing packet 116. For the second node timeline 162, the small timing packet 116 has started to overtake the large blocker packet 130 because its processing time is much shorter within the first node. Gap 155, which is considerably smaller than gap 153, represents the shorter lapse in time now between the end of large blocker packet 130 being processed by the second node and that start of processing for the small timing packet 116. For the third node timeline 164, the short timing packet 116 has caught up with the large blocker packet 130 and must wait for transmit processing of the large blocker 130 to be completed before it can be processed by the third node. For the fourth node timeline 166, the short timing packet 116 is still behind the large blocker packet 130 and must wait for it to complete processing before being sent. It is noted that it is assumed that the network nodes operate such that once transmission of a packet has started, that processing must be completed before another packet can be sent.

Looking to FIG. 1B (Prior Art), it can be seen that the trajectory of the small timing packet 116 through the network nodes is faster than the trajectory for the large blocker packet 130. As such, the small timing packet 116 tends to catch up to the large blocking packet 130 and must then wait behind the large blocker packet 130. The large blocker packet 130, therefore, causes packet delay in the transit time of the small timing packet 116. It can also be seen that if the large blocker packet 130 were not encountered by the small timing packet 116, then the transit time would likely be considerably faster. As described above, this possibility of encountering or not encountering one or more blocker packets during transit through the network nodes is one cause of unpredictable variability in packet delay associated with small timing packets communicated across one or more network links.

To address this variable delay problem with respect to timing packets, solutions have been introduced that attempt to determine an overall minimum delay within the communication paths. This minimum delay can then be applied; however, unpredictable network delays are difficult to account for in such delay calculations. The blocking phenomenon described herein can lead to situations where the apparent minimum delay is larger than the true minimum delay, which degrades the performance of packet-based time synchronization techniques. Other solutions have attempted to identify packets that fall outside an acceptable processing window by using complex selection and filtering algorithms. Timing information in timing packets failing the selection and/or filtering criteria can be discarded by the receiving system.

While these prior systems and techniques provide some ability to handle unpredictable variations in network delay associated with the timing packets utilized for implementing network timing protocols, it is desirable to provide more robust and less complex solutions.

### SUMMARY OF THE INVENTION

Systems and methods are disclosed for utilizing large packet sizes to reduce unpredictable network delay variations in delivering timing packets across networks for use with respect to network timing protocols. The embodiments described herein reduce or eliminate the blocking effect caused by size differences between timing packets and relatively large packets carried through a packet network by increasing the size of the timing packets. Because the unpredictable blocking effects caused by relatively larger packets provide one significant source of unpredictable packet delay variation, by reducing or eliminating this blocking effect, the embodiments described herein provide significant advantages in reducing the complexity of implementing robust timing protocols for handling unpredictable delays in the communication of timing packets. The size of timing packets can be increased, for example, by adding fill data to timing data to form large timing packets. For some embodiments, the timing packets can be made to be ninety percent or more of the maximum transmission unit (MTU) for the network, and timing packets can be preferably made to be equal to the MTU for the network. Other features and variations can be implemented, if desired, and related systems and methods can be utilized, as well.

In one embodiment, a network system is disclosed including a device coupled to one or more network nodes. The device includes a packet interface configured to transmit network packets through a network that utilizes a network protocol allowing for variable packet sizes and includes a timing packet generator configured to provide a plurality of timing packets to the packet interface for transmission through the network to one or more receiving devices, where the timing packet generator is further configured to form the plurality of timing packets by combining timing data with additional fill data. The one or more network nodes are configured to receive and process network packets including the plurality of timing packets, where the one or more network nodes are configured to store network packets before forwarding them and to complete transmission of network packets once transmission has started.

In a further embodiment, the additional fill data includes data that is intended for use by a receiving device. And in another further embodiment, the additional fill data comprises data that will be discarded by a receiving device. Still further, the plurality of timing packets can be configured to have a size of between twenty-five percent to one hundred percent of a maximum packet size for the network. In addition, the plurality of timing packets can be configured to have a size of between ninety percent to one hundred percent of a maximum packet size for the network. The plurality of timing packets can also have a size equal to a maximum packet size for the network.

In a still further embodiment, the device is a timing master device. Still further, the system can also include a timing slave device coupled to receive the plurality of timing packets through the one or more network nodes, where the timing slave device includes a timing packet interface configured to receive timing packets from the packet interface and a timing packet parser configured to receive the timing packets and to obtain timing data from the received timing packets. In a still further embodiment, the packet interface can be configured to receive timing packets from the network, and the device can further include a timing packet parser configured to receive timing packets from the packet interface, where the timing packet parser is configured to obtain timing data from the received timing packets.

In one other embodiment, a network device is disclosed that can be used in a network system. The network device includes a packet interface configured to transmit network packets through a network that utilizes a protocol allowing for variable packet sizes, where the network also utilizes network nodes configured to store network packets before forwarding them to receiving devices and to complete transmission of network packets once transmission has started. The network device also includes a timing packet generator configured to provide timing packets to the packet interface for transmission through the network to one or more receiving devices, where the timing packet generator is also configured to form timing packets by combining timing data with additional fill data.

In one further embodiment, a method is disclosed for network communications including forming a plurality of timing packets by combining timing data with additional fill data, and transmitting the plurality of timing packets through a network using one or more network nodes, where the network utilizes a network protocol allowing for variable packet sizes, and the one or more network nodes are configured to store network packets before forwarding them and to complete transmission of network packets once transmission has started. In a further embodiment, the method includes receiving the plurality of timing packets and obtaining timing data from the plurality of timing packets. Still further, the method can include performing the forming and transmitting steps using a timing master device and performing the receiving and obtaining steps using a timing slave device. Still further, the method can include utilizing a fixed packet size for the plurality of timing packets. And the method can include utilizing a variable packet size for the plurality of timing packets.

Other features and variations can be implemented, if desired, and related systems and methods can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1A (Prior Art) is a block diagram for a prior network system using small timing packets.

FIG. 1B (Prior Art) is a graphical depiction of a large blocker packet and a small timing packet progressing through four network nodes.

FIG. 2A is a block diagram for a network system utilizing large timing packets.

FIG. 2B is a graphical depiction a large blocker packet and a large timing packet progressing through three network nodes.

FIG. 3A is a block diagram of example network packets including large timing packets.

FIG. 3B is a chart showing packet size data associated with packet traffic on an example IP (internet protocol) network.

FIG. 4A is a block diagram of a network system having in-and-out interfering packets.

FIG. 4B is a block diagram of a network system having accumulative interfering packets.

FIG. 4C is a block diagram of a network system having hub-and-spoke interfering packets.

FIG. 5 is a block diagram of an embodiment for a network element (NE) that can be used in the network systems of FIGS. 4A, 4B and 4C.

FIG. 6 provides a timing diagram showing a small timing packet encountering a large blocker packet.

FIG. 7 is a block diagram of an embodiment for a network device that sends and/or receives network timing packets.

FIG. 8 is a flow diagram for sending and/or receiving large timing packets.

### DETAILED DESCRIPTION OF THE INVENTION

Systems and methods are disclosed for utilizing large timing packets to reduce unpredictable network delay variations associated with the delivery of timing packets through network links for use with respect to network timing protocols. The embodiments described herein reduce or eliminate the blocking effect caused by size differences between timing packets and other relatively large packets carried through a packet network by increasing the size of the timing packets. Because the unpredictable blocking effects caused by relatively larger packets provides one significant source of unpredictable packet delay variation, by reducing or eliminating this blocking effect, the embodiments described herein provide significant advantages in reducing the complexity of implementing robust timing protocols. Other features and variations can be implemented, if desired, and related systems and methods can be utilized, as well.

As described above, timing protocols have been developed for network communications to facilitate the synchronization of clocks used by different network devices. For many timing protocols, packets containing timing data are sent between a master device and a slave device so that the slave device can synchronize its local clock with the remote clock of the master device. Existing packet timing protocols, such as the Network Time Protocol (NTP) and the Precision Time Protocol (PTP), intentionally choose small sizes for timing packets because these small sizes result in efficient use of network capacity. These small timing packet sizes, for example, will often be on the order of about one hundred bytes where variable packets sizes of up to 1500 or more bytes are allowed, such as with Ethernet or IP based networks.

As further described above, even if small in size, timing packets can still be delayed by a variety of mechanisms as they are delivered through the network. Some delay mechanisms are predictable, and other delay mechanisms are not predictable. Predictable network delay mechanisms can typically be accounted for by the receiving device in the synchronization process. However, to the extent that the additional delay associated with timing packets is unpredictable or random, it is more difficult to compensate for this unpredictable or random delay in the synchronization process. For example, as described herein, the small packet sizes used by timing protocols such as NTP and PTP tend to subject these timing packets to the uncertainty of blocking by larger packets. This uncertainty causes unpredictably wide variations in packet delay for small timing packets being delivered across the network. To address this unpredictable variability in the packet delay, prior NTP and PTP solutions have used sophisticated and complex packet selection and filtering algorithms in an effort to achieve accurate time synchronization over network communication links.

In contrast with prior solutions that utilize small timing packets, the embodiments described herein instead use large packet sizes for timing packets to achieve an advantageous reduction in unpredictable network delay variations. The large packet sizes reduce the likelihood that timing packets will experience wide variations in encountering large blocker packets. As such, unpredictable delay variation in the delivery of timing packets is also reduced because large blocker packets are primary causes of unpredictable network delay. By reducing unpredictable network delay, the embodiments described herein reduce and/or eliminate the need for the complex selection and filtering techniques used by prior solutions. In particular, the large timing packets utilized by the embodiments described herein help to reduce random contributions to the packet delay from large blocker packets, thereby making the tasks of packet selection and filtering simpler and enabling lower cost synchronization networks to accomplish similar performance goals.

The packet sizes for the timing packets can be increased, for example, by adding additional fill data to the timing packet to thereby artificially increase the size of the timing packet. As described herein, the fill data can be additional useful data desired to be transmitted to the receiving system, and this useful fill data can then be utilized by the receiving system. The additional useful data can be any of a wide variety of data desired to be transmitted to the receiving system, including additional timing related data, if desired. The fill data may also be data that is of no use to the receiving system, and this non-useful data can be discarded by the receiving system. The fill data could further be a mix of useful and non-useful data. Further, the large timing packets used herein are preferably made as large as the largest packets on the network, although other large sizes could also be used for the timing packets. For example, timing packets can be sized such that they are 25 percent or more, 50 percent or more, 75 percent or more, 90 percent or more, 95 percent or more, or 99 percent or more of the maximum packet size or maximum transmission unit (MTU) of the network. Other increased packet sizes could also be selected for the large packet sizes, and a plurality of variable packet sizes could also be used for the timing packets, if desired.

The large timing packet techniques described herein are counter-intuitive because choosing larger packets sizes would typically be seen as leading to undesirable results, such as slower transit times and increased network load. However, although the increased size of the timing packets does increase the delay experienced by individual packets, the increased size advantageously reduces the uncertainty in network delay caused by the blocking effect of large blocker packets. Further, although this increased size does increase the load on the network, this increased load is not significant because timing packets usually represent a small fraction of the overall network bandwidth (e.g., often on the order of hundreds of timing packets per second). Thus, while increasing the transit time of individual timing packets and adding slightly to the overall network load, the embodiments described herein that use large timing packets nevertheless improve overall performance by reducing the unpredictable variation in packet delay for timing packets due to the unpredictable blocking effect of large blocker packets. Thus, the large timing packet techniques improve performance and reduce the cost of the synchronization network by reducing or eliminating the need for complex selection and filtering algorithms. Further, these large packet timing techniques can be used over larger networks and/or at lower packet rates than would otherwise be possible using the standard small timing packets due to the variability of blocking.

It is noted that the network environment within which the use of large timing packets is more advantageous include those that allow variable packet sizes and those that utilize store-and-forward packet processing within network nodes. Most packet networking equipment, such as switches and routers and other network nodes, process packets in a manner that is called store-and-forward processing. Store-and-forward processing requires that a packet must be fully received by the input port of the switch or router before it can be examined to decide what to do with it. One reason for this store-and-forward approach is that the packet checksum, which is typically located at the end of the packet, is usually validated before further processing so that packets containing errors can be discarded. This store-and-forward behavior, however, introduces delay, and the amount of that delay is proportional to the size of the packet. Shorter packets experience less store-and-forward delay than longer packets. Therefore, in the absence of other traffic, short packets travel through a network more quickly than long packets.

With respect to variable packet sizes, when a packet network carries a mixture of packet sizes, as is typically the case, the blocking phenomenon can occur. Specifically, when a small packet follows a large packet through a series of network elements (e.g., switches, routers, or other network processing nodes), the progress of the small packet can be limited, or blocked, by the larger packet.

This blocking effect can be more clearly understood by way of a vehicle traffic example. Imagine a two lane road that does not allow vehicles to pass each other. On that road, there are two types of vehicles, sports cars and dump trucks. The two lanes on the road represent the two directions that packets can be transmitted. The sports cars represent smaller packets, and the dump trucks represent larger packets. The sports cars travel more quickly along the road than the dump trucks, just as small packets travel more quickly through a packet network than large packets. If there are both sports cars and dump trucks on the road, then the amount of time that it takes for the sports cars to get from one end of the road to the other will vary depending on the presence of the dump trucks. The more dump trucks there are on the road, and the more pronounced the difference in speed between the sports cars and dump trucks, the greater will be the uncertainty in the time it takes for the sports cars to reach the end of the road. Because the number of dump trucks any given sports car will encounter is unpredictable, the transit time for each sports car is subject to wide and unpredictable variations.

The embodiments described herein artificially limit the speed of the sports cars (e.g., by adding in effect a governor to the engine) so that they travel at the same or similar speeds as the dump trucks. As a result, while the overall time it takes for the sports cars to reach the end of the road is increased, the uncertainty in the transit times for these sports cars is reduced or eliminated. In other words, because the blocking effect occurs as a result of the difference in size between the small timing packets (sports cars) and the large blocking packets (dump trucks) in the network, this blocking effect can be limited or removed by making the timing packets relatively larger and preferably as large as the largest packets carried on the network.

This goal of making the timing packets closer in size to large block packets can effectively be accomplished in two primary ways. First, the size of the timing packets can be increased by adding padding or other fill data to the timing packet. This padding or fill data can be, for example, unused information that is discarded by the receiving system, useful information that is used by the receiving system, or a mixture of both unused and useful information. In one implementation, for example, the timing packet can be combined with another large packet that would otherwise go to the same destination so that a single large timing packet is formed including the timing data and the data for the large packet. Second, the maximum packet size or maximum transmission unit (MTU) on the network could be reduced, for example to match or be closer to the smaller size of the timing packets. This second approach, however, is not particularly practical because it reduces the variability allowed in packet sizes. This variable packet size has advantages for reasons unrelated to the use of timing packets and associated timing protocols. Further, it is noted that a combination of smaller maximum packet sizes and artificially larger timing packets could be a useful combination of the above approaches. The embodiments described in more detail below utilize large timing packets; however, it is noted that other techniques could also be used in combination with large timing packets, if desired.

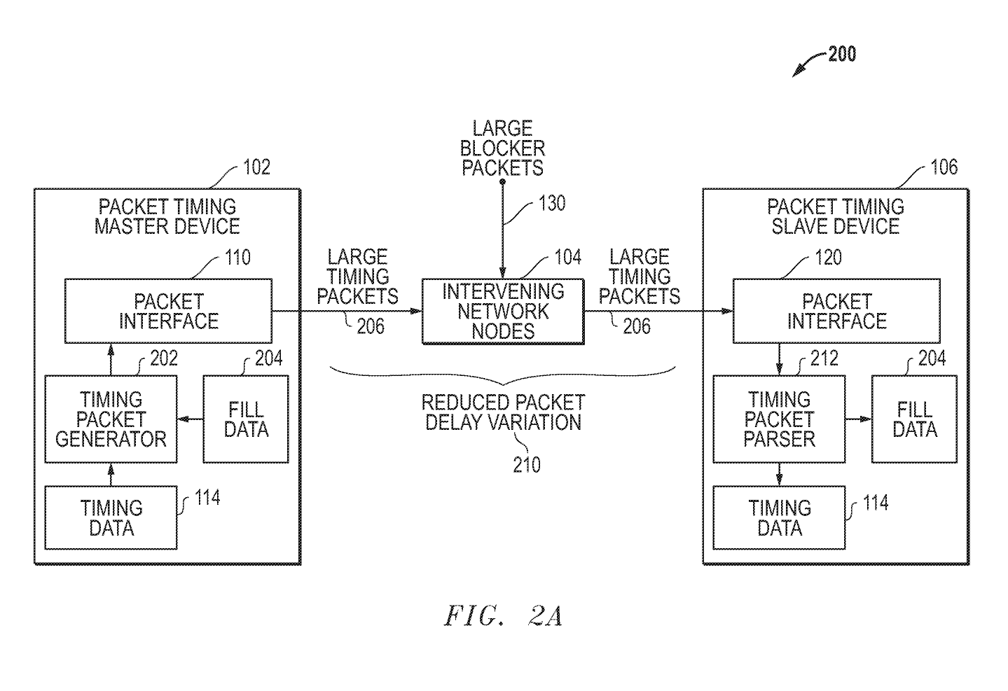

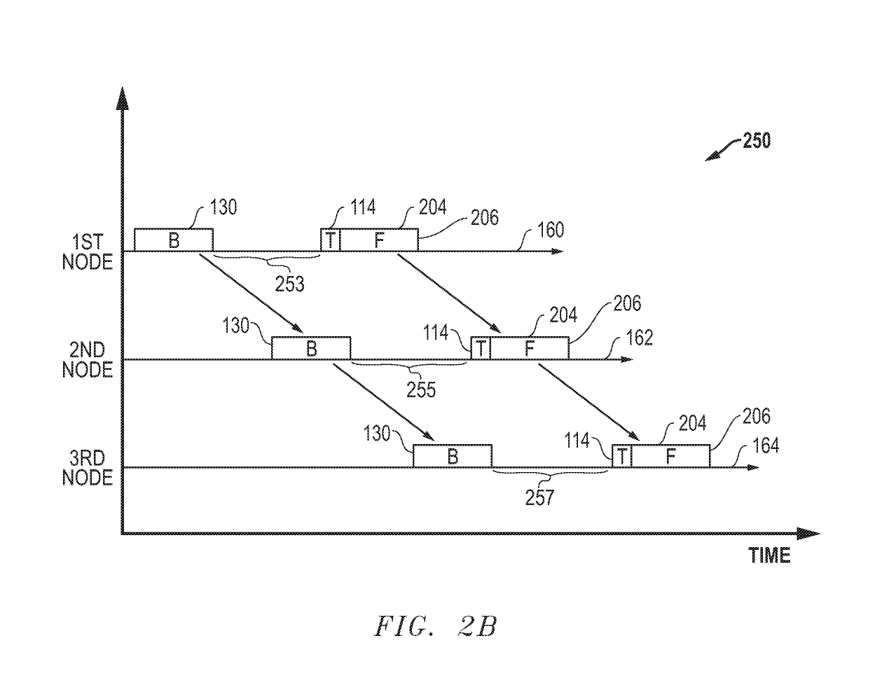

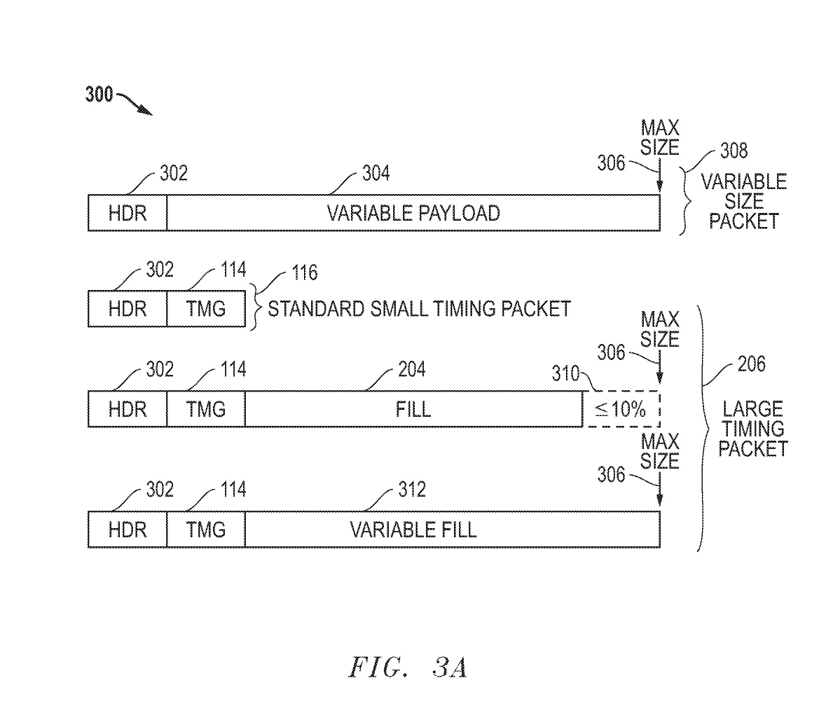

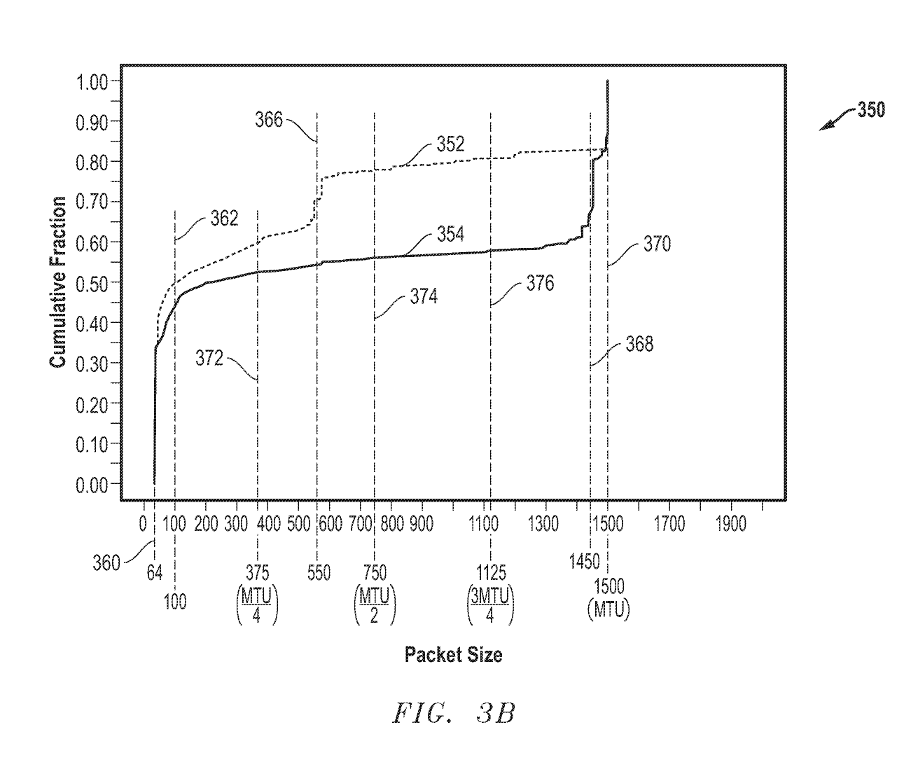

FIGS. 2A, 2B and 3A provide example diagrams for utilizing large timing packets with respect to the transmission of timing packets through networks.

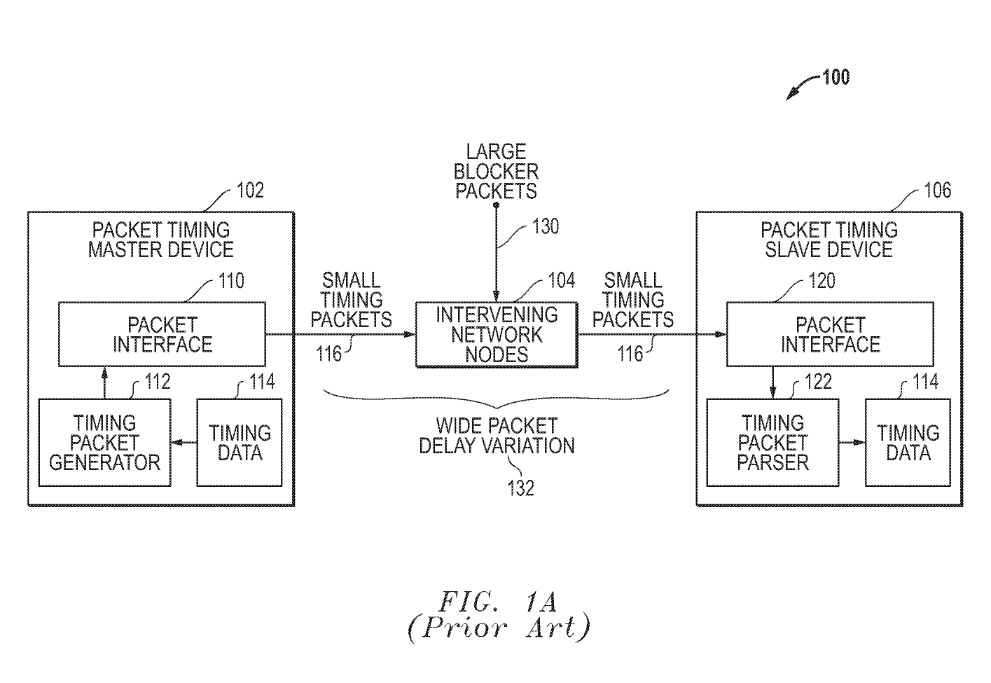

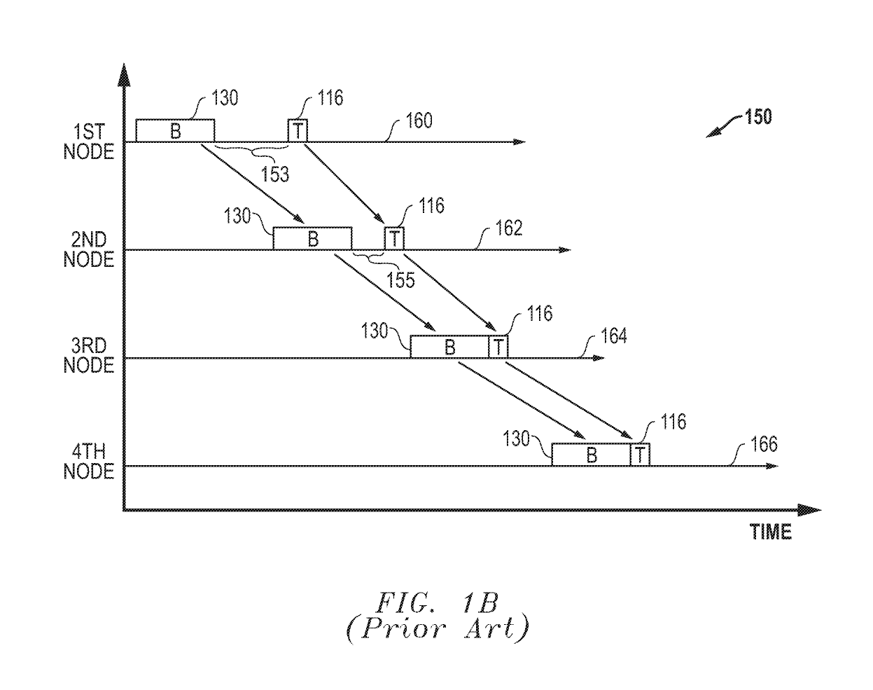

FIG. 2A is a block diagram for a network system 200 utilizing large timing packets 206 to provide reduced packet delay variation 210. As with network system 100 in FIG. 1A (Prior Art), network system 200 includes a packet timing master device 102 and a packet slave device 106 communicating through a network across one or more intervening network elements or nodes 104. However, unlike the network system 100, the network system 200 utilizes large timing packets for transmitting timing data through the network. Thus, while packet master and slave devices are again utilized, such as provided by the NTP and PTP standards mentioned above, the timing packet sizes are now comparatively large as compared to the small timing packet sizes traditionally used with network timing protocols, such as NTP and PTP.

In the embodiment depicted, the packet timing master device 102 includes a packet interface 110, a timing packet generator 202 and timing data 114. The packet timing master device 102 also includes fill data 204. The timing packet generator 112 combines the timing data 114 with the fill data 204 to form a large timing packet that is provided to the packet interface 110 for transmission across the network. The large timing packets 206 can also be tagged with a high priority designation so that network elements or nodes 104 will process them first over lower priority packets. The large timing packets 206 are then processed by one or more network elements or nodes 104 and then provided as large timing packets 206 to a destination or receiving device, which is the packet timing slave device 106 in network system 200. In the embodiment depicted, the packet timing slave device 106 includes a packet interface 120, a timing packet parser 212 and timing data 114. The packet timing slave device 106 also includes fill data 204. The packet interface 120 receives the large timing packets 206 and provides them to timing packet parser 212. Timing packet parser 212 obtains the timing data 114 from the timing packet, and this timing data 114 can then be used for timing synchronization. The timing packet parser 212 also removes the fill data 204. Depending upon what has been used for the fill data 204, the fill data 204 can be discarded and/or used by the packet timing slave device 106.

As described above, it is again noted that timing protocols, such as PTP and NTP, often require that the synchronizing devices send timing packets back and forth between each other for timing synchronization. Thus, in addition to timing data 114 sent from the packet timing master device 102 to the packet timing slave device 106, timing data would be sent back to the packet timing master device 102 from the packet timing slave device 106. Further, additional timing data could be used by the packet timing master device 102 and/or the packet timing slave device 106 other than the data received from each other. As further described above, for example, the data utilized and compared in a synchronization process can include SEND and RECEIVE timestamps associated with the timing packets communicated between the master device and the slave device.

In operation, the large timing packets 206 are less likely to encounter or catch up to one or more large blocker packets 130 as they progress through intervening elements or nodes 104. This blocking effect is less likely because the timing packets 206 are now larger and will move through the network at speeds that are the same or closer to the speeds of the large blocker packets 130. Thus, the large blocker packets 130 will cause less variability in packet delay associated with the large timing packets 206. A reduced packet delay variation 210 is thereby achieved. In other words, even though the large timing packets 206 will individually progress more slowly through the network as they travel through the intervening network elements or nodes 104, across multiple timing packets 206, the variability of the transmit time will be less. This reduction in packet delay variability improves the performance of timing protocols, such as NTP and PTP. As recognized herein, therefore, it is advantageous to overall system performance to slow down individual timing packets by making them relatively large so that they do not encounter the wide variability caused by large blocker packets 130. It is again noted that the large blocker packets 130 may leave the intervening network nodes 104 and travel to the same packet timing slave device 106 or to other network connected devices. It is again further noted that in addition to large blocker packets 130, other packets of differing sizes will likely enter and leave the intervening network nodes 104, and these additional packets may also interfere with and delay the small timing packets 116.

Thus, while the larger packet size for the timing packets can cause these packets to move more slowly through network links, the reduction in packet delay variability reduces the need for complex selection and/or filtering routines, thereby significantly reducing the complexity and improving the performance of timing protocols. It is further noted that a wide variety of implementations can be utilized to form and use larger timing packets, as desired, in order to reduce the impact of large blocker packets on unpredictable packet delay and thereby reduce packet delay variations.

FIG. 2B is a graphical depiction 250 of a large blocker packet 130 and a large timing packet 206 progressing through three network nodes. As described above, the large timing packet 206 includes timing data 114 and fill data 204. For the first node timeline 160, the blocker 130 is received and processed before the large timing packet 206 is received and processed. Gap 253 represents the time lapse from the end of large blocker packet 130 being processed by the first node and that start of processing for the large timing packet 206. For the second node timeline 162, the large timing packet 116 has not started to overtake the large blocker packet 130 because its processing time is about the same as the large blocker packet 130 within the first node. Gap 255, which is about the same as gap 253, represents a similar lapse in time now between the end of large blocker packet 130 being processed by the second node and that start of processing for the large timing packet 206. For the third node timeline 164, the large timing packet 116 still has not caught up with the large blocker 130. Gap 257, which is again about the same as gap 253 and gap 255, represents a similar lapse in time now between the end of large blocker packet 130 being processed by the third node and that start of processing for the large timing packet 206. As with FIG. 1B (Prior Art), it is again noted that it is assumed that the network nodes operate such that once transmission of a packet has started, that processing must be completed before another packet can be sent. Further, it is again assumed that the network nodes operate such that a packet must be fully received before it can be forwarded on to the next node or receiving device.

Looking to FIG. 2B, it can be seen that the trajectory of the large timing packet 206 through the network nodes is about the same as the trajectory for the large blocker packet 130. As such, the large timing packet 206 is less likely to catch up to the blocker packet 130 and be blocked. By limiting the likelihood that the timing packet 206 will catch up to large blocker packets 130, the large timing packets 206 will have reduced network delay variation as compared to the wide variability in network delay suffered by the small timing packets of the prior solutions.

FIG. 3A is a block diagram 300 providing examples for network packets including large timing packets 206. As described above, it is assumed that the network being utilized allows for variable packet sizes from a minimum packet size to a maximum packet size or maximum transmission unit (MTU) 306. The variable size packet 308 includes, for example, header (HDR) data 302 and payload data 304 of variable size. Other data, such as error check data, can also be included within the packet, as desired. The variable size of the network packets can be, for example, from less than 100 bytes to 1500 or more bytes (e.g., 1518 bytes). It is noted that the Ethernet and IP protocols are network protocols that allows for packets of variable size from less than 100 bytes to over 1500 bytes.

The standard timing packet 116 is small in size. For example, standard small timing packets 116 are often approximately 100 bytes or less. The standard timing packet 116 includes the header (HDR) data 302 and the timing data 114. As can be seen in FIG. 3, the standard small timing packet 116 is considerably smaller in size than the maximum packet size or MTU 306 allowed by the network protocol being used.

In contrast with the standard small timing packet 116, the timing packets 206 utilized by the embodiments herein are large in size. As described above, this large size is formed by combining fill data 204 with the timing data 114. As such, the large timing packet 206 includes header (HDR) data 302, timing data 114 and fill data 204. It is again noted that other data, such as error check data, can also be included within the packet, as desired.

A wide variety of sizes can be selected for the large timing packet 206. Preferably, however, the large timing packet 206 is made equal in size to the maximum packet size or MTU for the network so that it will be as large as the largest packets on the network. For the embodiment depicted in FIG. 3A, the fill data 204 is sized so that the large timing packet 206 will be 90 percent or more of the maximum packet size 306. In other words, the unused portion 310 of the allowable packet size is less than or equal to 10 percent. Other sizes could also be used for the large timing packets 206. For example, the timing packets could be made to be 95 percent or more of the maximum packet size 306 so that the unused portion 310 is 5 percent or less of the maximum packet size 306. The timing packets could also be made to be 99 percent or more of the maximum packet size 306 so that the unused portion 310 is 1 percent or less of maximum packet size 306. It is again noted, however, that other packet sizes could be selected for the large timing packet 206, as desired, depending upon the nature of the network traffic and performance requirements desired. For example, as discussed further with respect to FIG. 3B below, the large timing packet 206 can be sized to be about 10 percent or more of the available maximum packet size 306, to be about 25 percent or more of the available maximum packet size 306, to be about 50 percent or more of the available maximum packet size 306, or to be to be about 75 percent or more of the available maximum packet size 306. As stated above, the large timing packet 206 can preferably be made equal to the maximum packet size or MTU 306 so that the large timing packet 206 will tend to travel through the network at the same speed as the largest packets on the network.

It is also noted that the size of the timing packets could be chosen ahead of time based on knowledge of the network topology and the expected traffic loading conditions. In this situation, different networks may be configured to use different timing packet sizes according to the anticipated severity of the blocking effect. For example, the size of the timing packets could be selected ahead of time by a network operator using knowledge of, or anticipation of, actual network topologies and loads. However, if chosen as a fixed value, the size of the timing packets would remain the same regardless of actual network conditions. Alternatively, the size of the timing packets could be adjusted dynamically in response to measured packet delay variations. Changes to the size of the timing packet could be accomplished, for example, by observing an increase in packet delay variation and communicating an increased timing packet size between the master and slave devices. For example, the size of the timing packets could be changed dynamically via negotiations between the timing master and timing slave according to the observed packet delay variation. Other parameters could also be considered, if desired, in dynamically determining the packet size for the timing packets.

It is further noted that the fill data can also be implemented using a variable amount of fill data, as represented by variable fill data 312. In such an implementation, the large timing packet 206 includes header (HDR) data 302, timing data 114 and fill data 312 that is variable in size. As such, the packet size for the timing packet can be varied from a desired minimum size value to a desired maximum size value up to the maximum packet size or MTU 306. It is again noted that other data, such as error check data, can also be included within the packet, as desired.

As described above, the fill data 204/312 can be any desired data combined with the timing data 114. This fill data 204/312, for example, can be other data desired to be sent to the destination device for use by the destination device. The fill data 204/312 can also be data that is not for use by the destination device and can be discarded by the destination device once received. Further, the fill data 204/312 could also be implemented as a mix of data that is to be used by the destination device and data that is not to be used by the destination device. As such, a wide variety of implementations could be utilized in forming the large timing packets by adding fill data 204/312.

FIG. 3B is a chart 350 showing packet size data associated with packet traffic on an example IP (internet protocol) network. The vertical axis represents a cumulative fraction of the overall packet traffic on the example IP network. The horizontal axis represents the packet size in bytes. It is noted the data within chart 350 is associated with Internet traffic in 1998 as represented by dotted line 352 and Internet traffic in 2008 as represented by line 354. The packet size or MTU is about 1500 bytes as represented by dotted line 370. The minimum packet size is about 64 bytes as represented by dotted line 360. As can be seen in the example data of FIG. 3B, most of the Internet traffic occurred near the extremes with small packets having about 64 bytes and large packets having about 1500 bytes. For the 1998 traffic represented by dotted line 352, a higher volume of Internet traffic also occurred at about 550 bytes as represented by dotted line 366 due to legacy systems that assumed a maximum packet size or MTU of about 550 bytes. As seen for the 2008 traffic represented by line 354, this higher volume of traffic using about 550 bytes no longer occurred. Thus, looking at the 2008 traffic line 354, it is seen that most of the packets are under about 100 bytes as represented by dotted line 362 (e.g., about 6.7 percent of the MTU size) or are over about 1450 bytes as represented by dotted line 368 (e.g., about 96.7 percent of the MTU size). Also shown in FIG. 3B are dotted lines 372, 374 and 376. Dotted line 372 is located at 375 bytes and represents the location of one-fourth of the maximum packet size or MTU of 1500 bytes (MTU/4 or 25 percent of the MTU). Dotted line 374 is located at 750 bytes and represents the location of one-half of the maximum packet size or MTU of 1500 bytes (MTU/2 or 50 percent of the MTU). Dotted line 376 is located at 1125 bytes and represents the location of one-fourth of the maximum packet size or MTU size of 1500 bytes (3 MTU/4 or 75 percent of the MTU).

As stated above, the size chosen for the large timing packets, as increased by the addition of the fill data, can be selected as desired. However, based upon the traffic examples provided in FIG. 3B, it is assumed that most of the large blocker packets will likely have packets sizes near the maximum packet size or MTU. Thus, a timing packet size of about 90 percent or more of the maximum packet size or MTU could be used, if desired, and preferably the timing packet size can be made equal to the maximum packet size or MTU. Further, other sizes could also be selected. For example, a size of 10 percent of the maximum packet size or MTU could be selected for the timing packets, and as shown in FIG. 3B, the timing packets would then be larger than the significant number of packets that utilize packets sizes close to the minimum packet size. A size of 25 percent of the maximum packet size or MTU could also be selected for the timing packets, and as shown in FIG. 3B, the timing packets would again be larger than the significant number of packets that utilize packets sizes close to the minimum packet size. A size of 50 percent of the maximum packet size or MTU could be selected for the timing packets, and as shown in FIG. 3B, the timing packets would again be larger than the significant number of packets that utilize packets sizes close to the minimum packet size and would also be larger than the packets utilizing the large legacy packet size at about 550 bytes. A size of 75 percent of the maximum packet size or MTU could be selected for the timing packets; however, as shown in FIG. 3B, not many packets utilize mid-range sizes between 50 and 75 percent of the maximum packet size or MTU. Further, 90 percent or more of the maximum packet size or MTU could be selected so that the timing packets are close to the largest sized packets being used on the network. As described above with respect to FIG. 3A, for example, the unused portion of the maximum packet size or MTU could be less than or equal to 10 percent, 5 percent or 1 percent, so that the timing packet is 90 percent, 95 percent or 99 percent of the maximum packet size or MTU. It is again noted that the timing packets are preferably made to be equal in size to the maximum packet size or MTU so that they are as large as the largest blocker packets potentially traveling through the network.

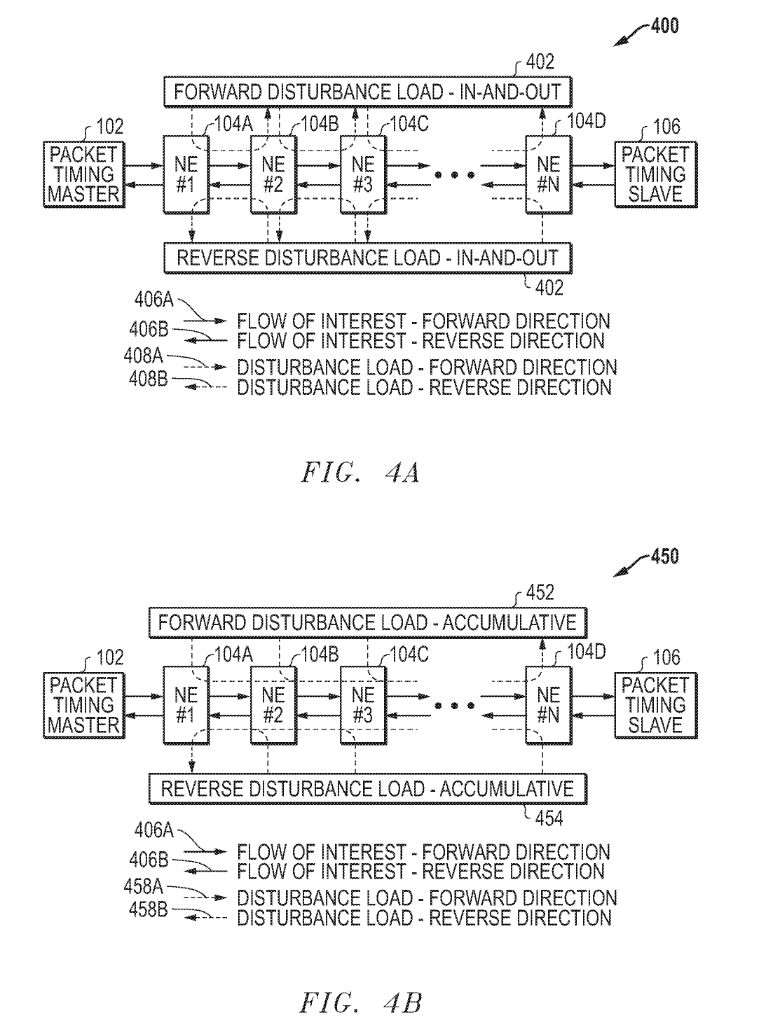

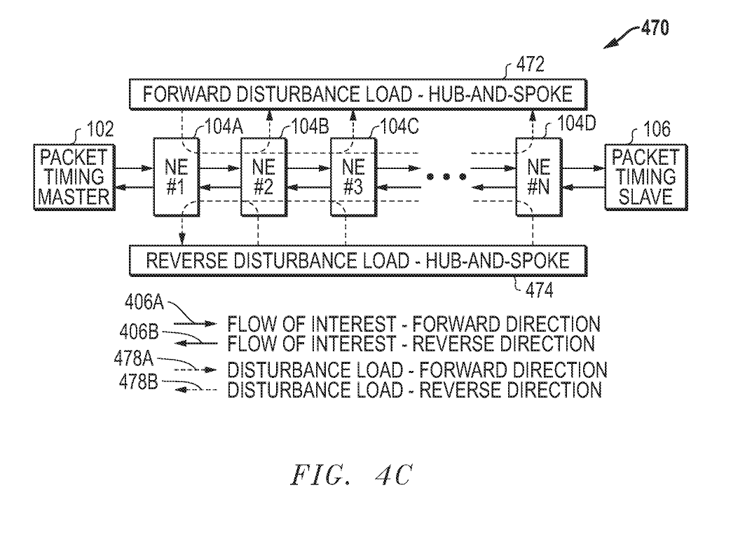

FIGS. 4A, 4B and 4C are block diagrams that provide examples for delay mechanisms in network environments due to potential blocker packets that are overcome by the large timing packet techniques described herein. When characterizing timing packet flow through networks, there are two architectures at the extremes for representing timing packets progressing from a timing source over a chain of network elements (NEs) to a timing destination. In one extreme case, interfering traffic or load that enters in one network element (j) then exits in the next network element (j±1). This structure, which can be referred to as an in-and-out structure, is depicted in FIG. 4A. In the other extreme case, all packets that enter the chain, including all interfering traffic or load, travel to the timing destination. This structure, which can be referred to as an accumulative structure, is depicted in FIG. 4B. Within this accumulative structure, an accumulation of traffic occurs because intermediate nodes collect traffic destined for the end-node. A more realistic structure for actual interfering traffic in a common hub-and-spoke network configuration would be a mixture of the extreme delay mechanisms shown in FIGS. 4A and 4B. FIG. 4C provides an example interfering structure of a hub-and-spoke network that includes a mix of in-and-out interfering packets as shown in FIG. 4A and accumulative interfering packets as shown in FIG. 4B.

FIG. 4A is a block diagram of a network system 400 having in-and-out interfering packets that are assumed to travel from one network element to the next. As depicted, the packet timing master device 102 is communicating to a packet timing slave device 106 through a plurality of network elements (NE#1, NE#2, NE#3 . . . NE#N) 104A, 104B, 104C . . . 104D. Forward disturbance load 402 represents disturbances in the forward flow in the direction from packet timing master device 102 to packet timing slave device 106. Reverse disturbance load 404 represents disturbances in the reverse flow in the direction from to packet timing slave device 106 to packet timing master device 102. The timing packet flows of interest in the forward direction 406A and the reverse direction 406B are represented by the solid arrows. The in-and-out disturbance loads in the forward direction 408A and the reverse direction 408B are represented by the dotted lines and arrows.

FIG. 4B is a block diagram of a network system 450 having accumulative interfering packets that are assumed to travel to the end-point once they enter the network path. As depicted, the packet timing master device 102 is communicating to a packet timing slave device 106 through a plurality of network elements (NE#1, NE#2, NE#3 . . . NE#N) 104A, 104B, 104C . . . 104D. Forward disturbance load 452 represents disturbances in the forward flow in the direction from packet timing master device 102 to packet timing slave device 106. Reverse disturbance load 454 represents disturbances in the reverse flow in the direction from to packet timing slave device 106 to packet timing master device 102. The timing packet flows of interest in the forward direction 406A and the reverse direction 406B are represented by the solid arrows. The accumulative disturbance loads in the forward direction 458A and the reverse direction 458B are represented by the dotted lines and arrows.

FIG. 4C is a block diagram of a network system 470 having hub-and-spoke interfering packets. As depicted, the packet timing master device 102 is communicating to a packet timing slave device 106 through a plurality of network elements (NE#1, NE#2, NE#3 . . . NE#N) 104A, 104B, 104C . . . 104D. Forward disturbance load 472 represents disturbances in the forward flow in the direction from packet timing master device 102 to packet timing slave device 106. Reverse disturbance load 474 represents disturbances in the reverse flow in the direction from to packet timing slave device 106 to packet timing master device 102. The timing packet flows of interest in the forward direction 406A and the reverse direction 406B are represented by the solid arrows. The hub-and-spoke disturbance loads in the forward direction 478A and the reverse direction 478B are represented by the dotted lines and arrows. As such, each network element (NE#1, NE#2, NE#3 . . . NE#N) 104A, 104B, 104C . . . 104D can have a mix of in-and-out interfering packets and accumulative interfering packets.

It is further noted that certain operational aspects of the network system in FIGS. 4A, 4B and 4C are assumed with respect to how packets are being processed by the NEs 104A, 104B, 104C . . . 104D. The following are a summary of these assumptions:
1. Store-and-forward delay—Each network element (NE) introduces a store-and-forward delay. This store-and-forward delay results from the assumption that a packet is processed by the NE only after its last bit has been received, for example, so that its frame checksum can be verified. The store-and-forward delay for a packet may be calculated as the size of the packet (in bits) divided by the ingress port bit rate. Thus, larger packets experience larger store-and-forward delay.
2. No transmit interruption—It is assumed that once a NE has begun transmitting a packet on a port, this transmission cannot be interrupted for any reason, even if a higher priority packet becomes available while a lower priority packet is being transmitted.
3. Packet latency—In the absence of other packets, it assumed that the packet latency through a NE is the sum of a constant intrinsic delay (mu) plus the store-and-forward delay. Other interfering packets cause additional queuing delays.
4. Packet priority—It assumed that timing packets have the highest priority. All other streams have lower priority.

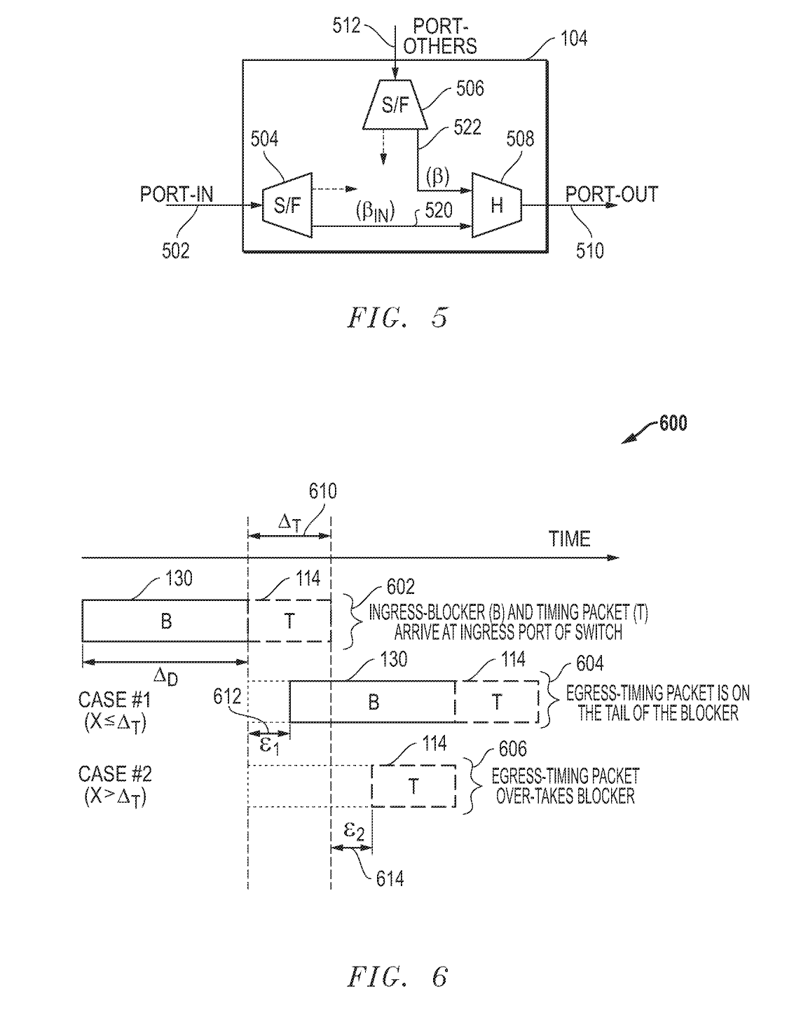

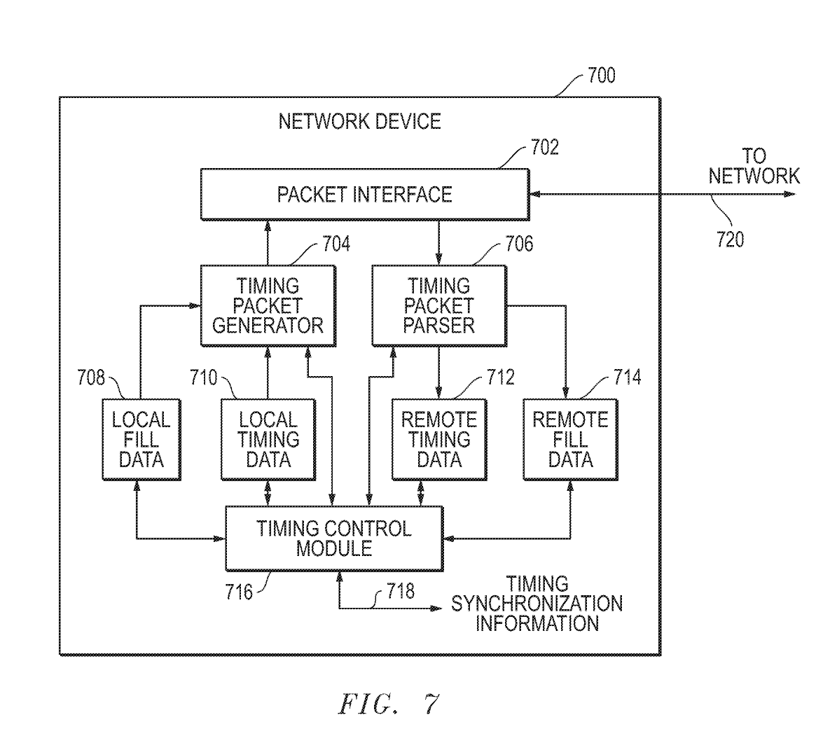

Regardless of the blocking delay mechanisms from FIGS. 4A, 4B and 4C that occur in the network (e.g., in-and-out disturbances, accumulative disturbances, or mixture of both), the embodiments described herein reduce or eliminate the blocking effect caused by size differences between timing packets and relatively large packets carried through a packet network by increasing the size of the timing packets. Because the unpredictable blocking effect of blocker packets provide one significant source of unpredictable packet delay variation, by reducing or eliminating this blocking effect, the embodiments described herein provide significant advantages in reducing the complexity of implementing robust timing protocols. This improvement is described further with respect to FIG. 5 and FIG. 6 below.

FIG. 5 is a block diagram of an embodiment for a network element (NE) 104 that can be used in the network systems of FIGS. 4A, 4B and 4C. For the embodiment depicted, the NE 104 includes a port-in (PORT-IN) port 502 and a port-out (PORT-OUT) port 510 that are associated with the network stream associated with the timing packets. The NE 104 also includes one or more other ports (PORT-OTHER) 512 associated with other networks streams and related packets. The NE 104 also includes store-and-forward (S/F) blocks 504 and 506 associated with the ingress ports 502 and 512, and a hold (H) block 508 associated with the egress ports 510. A load percentage (β_{IN}) is associated with the path 520 for the timing packets, and a load percentage (β) is associated with the path 522 for other packets.

In operation, a timing packet enters the port-in port 502 and exits the port-out port 510. Other traffic entering in the port-in port 502 may also exit through the port-out port 510. Further, some traffic from other-ports 512 may also be switched to exit the port-out port 510. With respect to the in-and-out disturbance structure depicted in FIG. 4A, only the timing packet would travel from the port-in port 502 to the port-out port 510, while all other traffic exiting the port-out port 510 would come from one or more other-ports 512. With respect to the accumulative structure depicted in FIG. 4B, all incoming traffic from the port-in port 502 and from the other-ports 512 would leaves through the port-out port 510. It is noted that a typical operation of a NE 104 would expect to involve a mixture of these two modes. It is also noted that the load on the outgoing line of the port-out port 510 for an NE 104 would be equal to the loading on the incoming line of the port-in port 502 of the subsequent NE 104. While the above is being shown in the forward direction of FIGS. 4A, 4B and 4C, the reverse directions would operate in a similar fashion.

The load percentage (β) in path 522 represents the additive load in the NE 104 that will interfere with the timing packet as well as other flows entering on the port-in port 502 and destined to the port-out port 510. The load percentage (β_{IN}) in path 522 represents the load in the NE 104 that has entered on the same port as the timing packet and therefore can potentially interfere with the timing packet through the blocking mechanism. The effective load on the outgoing line for the port-out port 512 can therefore be represented as β_{TOTAL}=β+β_{IN}.

As described herein, one consequence of traffic in the path is the possibility of blocking. Given the network disturbances in FIGS. 4A-4C or a mix thereof, if a timing packet finds itself behind another packet from a different stream, it can find itself continually behind this packet, even though the interferer is of lower priority. For example, suppose that in NE#1 104A, a small timing packet leaves shortly after a large blocker packet. In NE#2 104B, the separation between the packets is reduced because of the difference in sizes of the packets. In a lightly loaded network, the small timing packet will tend to catch up to the large blocker packet, and once it has caught up, it will still tend to remain behind the larger blocker packet. The reason for this result is that even if the small timing packet arrives immediately after the large blocker packet, the NE will not do anything with the small timing packet until it has been fully received due to store-and-forward delay. In this time, the NE can likely process the large blocker packet and begin transmitting it out another port. By the time that the small timing packet is ready to transmit, the transmitting port is already busy transmitting the large blocker packet. The small timing packet must then wait for the large blocker packet to finish. This blocking behavior persists until either the large blocker packet is no longer in front of the small timing packet, or the large blocker packet experiences head-of-line blocking delay greater than the store-and-forward delay of the small timing packet. For this second case, the small timing packet will be able to overtake the large blocking packet within the NE.

FIG. 6 provides a timing diagram 600 showing a small timing packet 114 encountering a large blocker packet 130. In timeline 602 at the ingress port, the timing packet (T) 114 arrives at the ingress port of the NE on the tail of the blocker packet (B) 130. The time required to receive and store the timing packet (T) 114 is represented by store delay time (ΔT) 610.

The timeline 604 represents a first case (CASE #1) where head-of-line delay time (X) for the blocker packet (B) 130 is less than the store-and-forward delay time (ΔT) 610 for the timing packet (T) 114. For this first case (X≦ΔT), therefore, the blocker packet (B) 130 has experienced no waiting, or it experiences a head-of-line blocking delay (X) of less than the timing packet's store-and-forward delay (ΔT) 610. As a consequence, the blocking packet (B) 130 starts being transmitted out the egress port before the timing packet (T) 114 has been completely received, as shown by the delay (ε₁) 612 being less than the store-and-forward delay (ΔT) 610 for the timing packet (T) 114. For this first case (CASE #1), the timing packet then remains on the tail of the blocker packet (B) 130.

The time line 606 represents a second case (CASE #2) where head-of-line delay time (X) for the blocker packet (B) 130 is greater than the store-and-forward delay time (ΔT) 610 for the timing packet (T) 114. For this second case (X>ΔT), therefore, the blocking packet (B) 130 experiences a head-of-line blocking delay (X) of greater than the store-and-forward delay (ΔT) of the timing packet (T) 114. As a consequence, before the blocking packet (B) 130 can start being transmitted, the timing packet (T) 114 has been completely received. Because of its higher priority, the timing packet (T) 114 then overtakes the blocker packet (B) 130. The timing packet (T) 114, therefore, is transmitted first after some delay (ε₂) 614 associated with the processing within the NE 104. It is noted, however, that the interfering packet that caused the head-of-line delay for the blocker packet (B) 130 can itself become a blocker packet at the next NE. This result is likely because this interfering packet was large enough to introduce a head-of-line blocking delay greater than the store-and-forward delay for the timing packet (T) 114.

As described herein, the use of large timing packets reduces or eliminates the blocking effect caused by size differences between large timing packets and other large packets carried through a packet network. By increasing the size of the timing packets, the likelihood of the large timing packet catching up to and being blocked by a large blocker packet is reduced or eliminated. Because the unpredictable blocking effect of blocker packets provide one significant source of unpredictable packet delay variation, by reducing or eliminating this blocking effect, the embodiments described herein provide significant advantages in reducing the complexity of implementing robust timing protocols.

Protocols, such as CES (Circuit Emulation Service) or TOP (Timing over Packet) or SATOP (Structure Agnostic TDM over Packet), can also benefit from the techniques disclosed herein. These protocols differ from PTP and NTP in that they transfer a fixed information rate from the master device to the slave device. Because the information rate is fixed, choosing a relatively large packet size simply means that fewer packets must be sent from the master device to the slave device, and would not require that the protocol add unused padding bytes to the packets. In other words, the fill data described above would simply be additional timing related data that is used to increase the size of the typical small timing packet used by these protocols. For example, for the CES and SATOP protocols, T1 or E1 data is transmitted across a packet network by taking blocks of consecutive bits from the T1 or E1 bitstream, placing them into the payload of a packet and transmitting those packets across a network. Currently, these packets are on the order of 200 bytes, but would be subject to the same blocking effect as PTP and NTP packets experience. If instead, the CES and/or SATOP protocol chooses to take larger blocks of consecutive bits from the T1 or E1 signal, the blocking effect would be reduced, and the packet rate would also be reduced (i.e., the fill data or padding bytes would be used by the slave instead of being discarded).

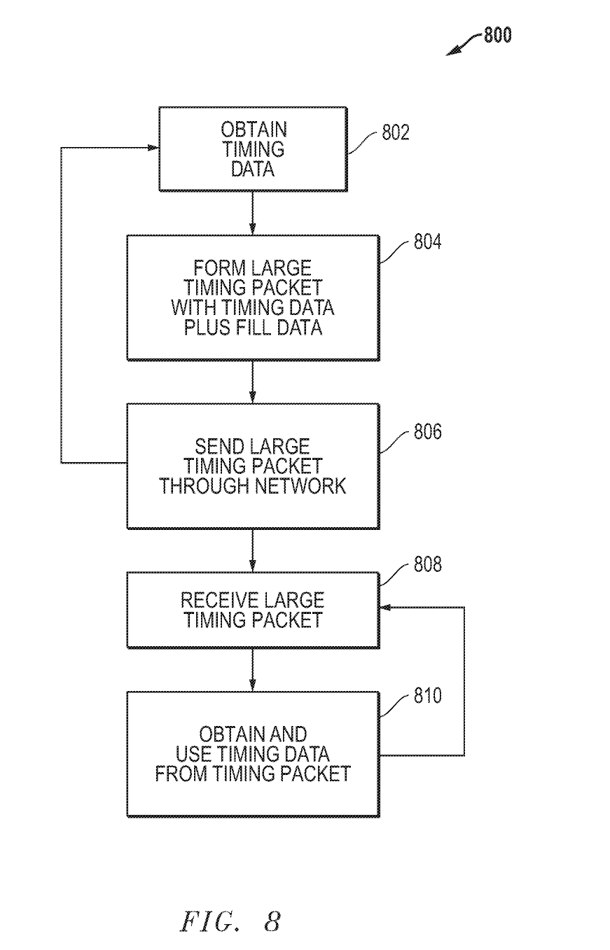

It is further noted that a wide variety of networks and network devices could be implemented that utilize the large timing packets described herein. As noted above, network devices could both transmit and receive timing packets. FIGS. 7 and 8 provide example implementations where network devices can be configured to transmit large timing packets, receive large timing packets or transmit and receive large timing packets.

FIG. 7 is a block diagram of an embodiment for a network device 700 that sends and/or receives network timing packets. As indicated above, timing protocols such as NTP and PTP often require synchronizing devices to send packets back and forth to each other. For the embodiment depicted, the network device 700 includes a packet interface 702 that communicates with the network through communication link 720. The network device 700 also includes timing packet generator 704 that forms timing packets using local timing data 710 and local fill data 708. The network device 700 also includes timing packet parser 706 that obtains remote timing data 712 and remote fill data 714 from timing packets received from remote devices. The timing packet generator 704 and the timing packet parser 706 communicate with the packet interface 702 to send timing packets to the network and to receive timing packets from the network. The network device 700 can also include a timing control module 716 that is configured to control the operations of the timing packet generator 704, the generation of the local timing data 710 and local fill data 708, the timing packet parser 706, and the processing of receiving timing packets to obtain the remote timing data 712 and the remote fill data 714. Further, the timing control module 716 can communicate with other blocks and/or circuitry within the network device 700 to send and receive timing synchronization information 718. This timing synchronization information 718 can include, for example, control data, resulting timing data and/or other data related to the timing synchronization operations of the network device 700.

It is also noted that if a network device 700 were configured to only transmit timing packets, this transmit-only network device 700 would not need the timing packet parser 706. As such, a transmit-only network device 700 would not obtain remote timing data 12 or remote fill data 714 from timing packets received through the network. Similarly, if a network device 700 were configured to only receive timing packets, this receive-only network device 700 would not need the timing packet generator 704. As such, a receive-only network device 700 would not form timing packets using the local timing data 710 or local fill data 708. It is further noted that a wide variety of network devices could utilize the large timing packet techniques described herein.

FIG. 8 is a flow diagram 800 for sending and/or receiving large timing packet sizes associated with network timing protocols. In block 802, timing data is obtained. In block 804 a large timing packet is formed using timing data and fill data. In block 806, the large timing packet is sent through the network. Flow then proceeds back to block 802, for example, where additional timing data is obtained for sending through the network in large timing packets. Flow also passes to block 808 where a large timing packet is received. In block 810, timing data is obtained from the timing packet and used. It is further noted that the fill data could also be obtained from the timing packet and used, if desired. Flow then proceeds back to block 808, for example, where additional large timing packets are received.

It is noted that network devices can be configured only to transmit timing packets, only to receive timing packets, or to both transmit and receive timing packets. A network device only transmitting timing packets could be configured to periodically perform steps 802, 804 and 806. A network device only receiving timing packets could be configured to periodically perform steps 808 and 810. And a network device transmitting and receiving timing packets could be configured to periodically perform steps 802, 804, 806, 808 and 810. Other variations could also be implemented, as desired.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A network system, comprising:
a device coupled to a network, the device comprising:
a packet interface configured to transmit network packets through a network, the network utilizing a network protocol allowing for variable packet sizes; and
a timing packet generator configured to provide a plurality of timing packets to the packet interface for transmission through the network to one or more receiving devices, the timing packet generator being configured to form the plurality of timing packets by combining timing data with additional fill data; and
one or more network nodes configured to receive and process network packets including the plurality of timing packets, the one or more network nodes being configured to store network packets before forwarding them and to complete transmission of network packets once transmission has started.

2. The network system of claim 1, wherein the additional fill data comprises data that is intended for use by a receiving device.

3. The network system of claim 1, wherein the additional fill data comprises data that will be discarded by a receiving device.

4. The network system of claim 1, wherein the plurality of timing packets have a size of between twenty-five percent to one hundred percent of a maximum packet size for the network.

5. The network system of claim 4, wherein the plurality of timing packets have a size of between ninety percent to one hundred percent of a maximum packet size for the network.

6. The network system of claim 5, wherein the plurality of timing packets have a size equal to a maximum packet size for the network.

7. The network system of claim 1, wherein the device comprises a timing master device.

8. The network system of claim 7, further comprising a timing slave device coupled to receive the plurality of timing packets through the one or more network nodes, the timing slave device comprising a timing packet interface configured to receive timing packets from the packet interface and a timing packet parser configured to receive the timing packets and to obtain timing data from the received timing packets.

9. The network system of claim 1, wherein the packet interface is further configured to receive timing packets from the network, and wherein the device further comprises a timing packet parser configured to receive timing packets from the packet interface, the timing packet parser being configured to obtain timing data from the received timing packets.

10. The network system of claim 1, wherein the network protocol comprises the Ethernet protocol.

11. The network system of claim 1, wherein the timing packet generator is configured to utilize a timing protocol comprising at least one of PTP (Precise Time Protocol) and NTP (Network Time Protocol).

12. A network device, comprising:
a packet interface configured to transmit network packets through a network, the network utilizing a protocol allowing for variable packet sizes, and the network utilizing network nodes configured to store network packets before forwarding them to receiving devices and to complete transmission of network packets once transmission has started; and
a timing packet generator configured to provide timing packets to the packet interface for transmission through the network to one or more receiving devices, the timing packet generator being configured to form timing packets by combining timing data with additional fill data.

13. The network device of claim 12, wherein the additional fill data comprises data that is intended for use by a receiving device.

14. The network device of claim 12, wherein the additional fill data comprises data that will be discarded by a receiving device.

15. The network device of claim 12, wherein the plurality of timing packets have a size of between twenty-five percent to one hundred percent of a maximum packet size for the network.

16. The network device of claim 15, wherein the plurality of timing packets have a size of between ninety percent to one hundred percent of a maximum packet size for the network.

17. The network device of claim 16, wherein the plurality of timing packets have a size equal to a maximum packet size for the network.

18. The network device of claim 12, wherein the packet interface is further configured to receive timing packets from the network, and wherein the device further comprises a timing packet parser configured to receive timing packets from the packet interface, the timing packet parser being configured to obtain timing data from the received timing packets.

19. The network device of claim 12, wherein the network protocol comprises the Ethernet protocol.

20. The network device of claim 12, wherein the timing packet generator is configured to utilize a timing protocol comprising at least one of PTP (Precise Time Protocol) and NTP (Network Time Protocol).

21. A method for network communications, comprising:
forming a plurality of timing packets by combining timing data with additional fill data; and
transmitting the plurality of timing packets through a network using one or more network nodes, the network utilizing a network protocol allowing for variable packet sizes, and the one or more network nodes being configured to store network packets before forwarding them and to complete transmission of network packets once transmission has started.

22. The method system of claim 21, further comprising using additional fill data intended for use by a receiving device.

23. The method of claim 21, further comprising additional fill data intended to be discarded by a receiving device.

24. The method of claim 21, wherein the forming step comprises forming the plurality of timing packets to have a size of between twenty-five percent to one hundred percent of a maximum packet size of the network.

25. The method of claim 21, wherein the forming step comprises forming the plurality of timing packets to have a size of between ninety percent to one hundred percent of a maximum packet size of the network.

26. The method of claim 21, wherein the forming step comprises forming the plurality of timing packets to have a size equal to a maximum packet size of the network.

27. The method of claim 21, wherein the network protocol comprises the Ethernet protocol.

28. The method of claim 21, further comprising utilizing a timing protocol comprising at least one of PTP (Precise Time Protocol) and NTP (Network Time Protocol).

29. The method of claim 21, further comprising receiving the plurality of timing packets and obtaining timing data from the plurality of timing packets.

30. The method of claim 29, further comprising performing the forming and transmitting steps using a timing master device and performing the receiving and obtaining steps using a timing slave device.

31. The method of claim 21, further comprising utilizing a fixed packet size for the plurality of timing packets.

32. The method of claim 21, further comprising utilizing a variable packet size for the plurality of timing packets.
